(19) United States
(12) Patent Application Publication
(10) Pub. No.: US 2022/0020370 A1
(43) Pub. Date: Jan. 20, 2022

(54) WIRELESS AUDIO TESTING

(71) Applicant: Google LLC, Mountain View, CA (US)

(72) Inventor: Jonathan D. Hurwitz, Cupertino, CA (US)

(21) Appl. No.: 17/309,609

(22) PCT Filed: Jul. 29, 2019
(86) PCT No.: PCT/US2019/043957

§ 371 Date: Jun. 10, 2021

(51) Int. Cl. G10L 15/22

(52) U.S. Cl. CPC G10L 15/22; G10L 2015/088; G10L 2015/223

(57) ABSTRACT

A method includes outputting, by a computing device, to a remote computing device, test audio data; determining, by the computing device, whether audio data detected by an audio input device includes the test audio data; and responsive to determining that the test audio data was not detected by the audio input device, temporarily refraining, by the computing device, from outputting advisory audio data indicating the audio input device is ready to receive a spoken audio command.

### BACKGROUND

Computing devices often receive audio data wirelessly from another computing device. For example, wireless headphones or a vehicle head unit may receive audio data from a mobile computing device for playback via speakers in the headphones or the vehicle. The speakers may not output all of the audio data received from the mobile computing device. For example, the device that receives audio data from the mobile computing device may not receive all of the data packets sent by the mobile computing device (e.g., due to a poor wireless connection) or the volume of the vehicle's speakers may be turned down.

### SUMMARY

In general, this disclosure is directed to techniques for enabling a computing system to perform audio testing. In some examples described in this disclosure, a computing system includes two computing devices that are wirelessly coupled to one another (e.g., via BLUETOOTH®, WIFI®, etc.). For example, a mobile computing device, such as a smartphone, may be communicatively coupled to a different computing device, such as a wireless speaker or vehicle head unit. In one example, the different computing device is configured to receive audio data from the mobile computing device and output the audio data via one or more speakers. In other examples, the mobile computing device is configured to both transmit the audio data via one or more speakers of the mobile computing device and to receive the audio data via one or more microphones of the mobile computing device.

In some scenarios, the mobile computing device performs a test to determine whether audio data transmitted from the mobile computing is output by the different computing device in such a way that the audio data is audible by a user in proximity to the different computing device. In one scenario, the mobile computing device transmits test audio data to the different computing device for output by a speaker of the different computing device. In such scenarios, the mobile computing device determines whether audio detected by a microphone includes the test audio data. If the detected audio data does not include the test audio data, this may indicate an issue with outputting the test audio data, such as a poor wireless connection between the mobile computing device and the different computing device, or having the speaker volume turned down too low. The mobile computing device may refrain from transmitting application audio data (e.g., audio data associated with an application, such as a music application, or an assistant application) to the different computing device when the test audio data is not detected and/or output a notification indicating the test audio data was not detected. Amongst other benefits, this may ensure that application audio data is not transmitted to the different computing device until the test has indicated the system is operating as intended.

In this way, techniques of this disclosure may enable the mobile computing device to determine whether audio output by a speaker includes test audio data. The mobile computing device may refrain from transmitting application audio data to the different computing device when the detected audio data does not include the test audio data. Refraining from transmitting application audio data between the mobile computing device and different computing device may reduce network traffic exchanged with the different computing device, for example, by reducing or eliminating the amount of application audio data re-transmitted when the test audio data was not output by the different speakers or was not heard. Additionally or alternatively, the mobile computing device may refrain from listening for and processing user voice commands when the test audio data is not detected. For instance, when the detected audio data does not include the test audio data (e.g., the test audio data is not detected), a user may be unable to hear a confirmation of the voice command or a response to the voice command due to audio not being output from the different speakers in the manner intended. Refraining from processing user voice commands when the test audio data is not detected may reduce the computations performed by the mobile device in such a scenario. In some instances, refraining from processing the user voice commands when test audio data, e.g. previously transmitted to the different device from the mobile device, has not been detected in audio received at the mobile device, may improve the user experience by ensuring that the mobile computing device outputs audio data acknowledging commands and/or responding to commands when the commands are given only when preceding test audio data has been detected in audio received at the mobile device. This has the potential to increase user confidence with regard to when voice commands are being executed and/or when the voice commands are not being executed.

In one example, a method includes: outputting, by a computing device, test audio data; determining, by the computing device, whether audio data detected by an audio input device includes the test audio data; and responsive to determining that the test audio data was not detected by the audio input device, temporarily refraining, by the computing device, from outputting advisory audio data indicating the audio input device is ready to receive a spoken audio command

In another example, a computing device includes at least one processor; and a memory. The memory includes instructions that, when executed by the at least one processor, cause the at least one processor to: output test audio data; determine whether audio data detected by an audio input device includes the test audio data; and responsive to determining that the test audio data was not detected by the audio input device, temporarily refrain from outputting advisory audio data indicating the audio input device is ready to receive a spoken audio command.

In another example, a computer-readable storage medium is encoded with instructions that, when executed by at least one processor of a computing device, cause the at least one processor to: output test audio data; determine whether audio data detected by an audio input device includes the test audio data; and responsive to determining that the test audio data was not detected by the audio input device, temporarily refrain from outputting advisory audio data indicating the audio input device is ready to receive a spoken audio command.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system that is configured to perform audio testing, in accordance with one or more aspects of the present disclosure.

FIG. 2 is a block diagram illustrating an example computing device that is configured to perform audio testing, in accordance with one or more aspects of the present disclosure.

FIG. 3 is a flowchart illustrating example operations of a computing device that is configured to perform audio testing, in accordance with one or more aspects of the present disclosure.

### DETAILED DESCRIPTION

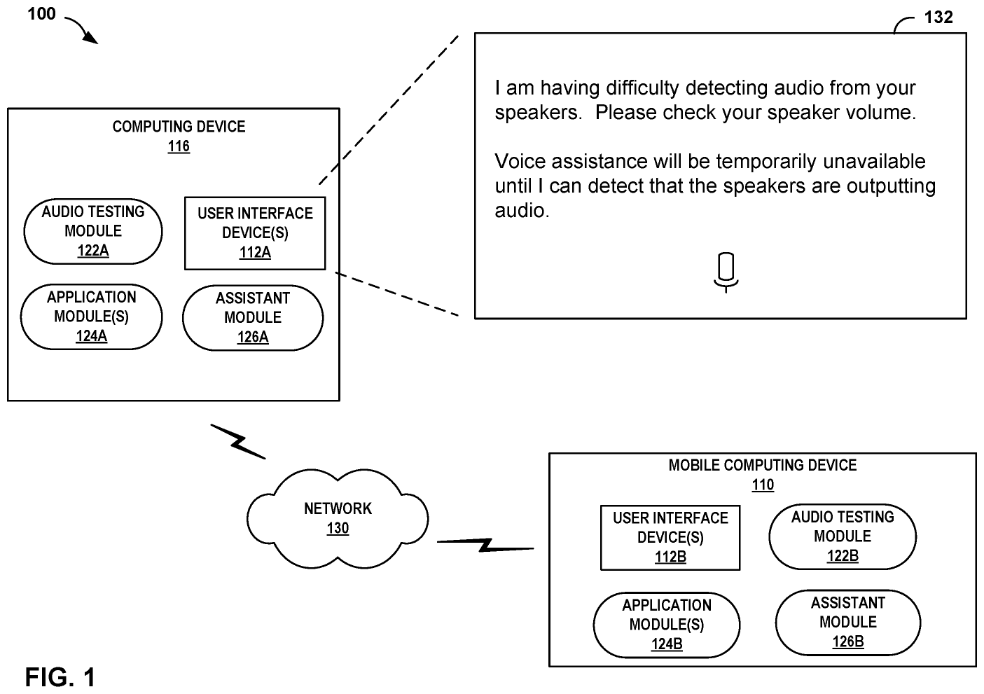

FIG. 1 is a conceptual diagram illustrating an example system that is configured to perform audio testing, in accordance with one or more aspects of this disclosure. System 100 includes a computing device 116 communicatively coupled to mobile computing device 110 via network 130.

Network 130 represents a wired or wireless communications network that directly couples computing device 116 and mobile computing device 110 to one another. Examples of network 130 include WIFI, WIFI Direct, BLUETOOTH, near-field communication (NFC), universal serial bus (USB), among others. Mobile computing device 110 and computing device 116 may exchange data, such as audio data, with one another when computing device 116, 110 are communicatively coupled to one another via network 130.

In the example of FIG. 1, computing device 116 and mobile computing device 110 are co-located. For example, computing device 116 and mobile computing device 110 may be located in proximity to one another (e.g., within the same vehicle or within the same room). That is, computing device 116 and mobile computing device 110 may be located within a threshold distance of one another (e.g., between approximately 0 meters and approximately 100 meters). As one example, the threshold distance may be defined by a maximum distance of wireless signals exchanged via network 130 (e.g., 10 meters when using a BLUETOOTH network).

Computing device 116 and mobile computing device 110 include one or more user interface devices (UIDs) 112A and 112B, respectively. UIDs 112A and 11B (collectively, user interface devices 112 or UIDs 112) function as input and/or output devices for computing devices 116, 110, respectively. Examples of input devices include a presence-sensitive input device (e.g., a touch sensitive screen), a mouse, a keyboard, an imaging device (e.g., a video camera), microphone, or any other type of device for detecting input from a human or machine. Examples of output devices include a display device (e.g., a light emitting diode (LED) display device or liquid crystal display (LCD) device, a sound card, a speaker, or any other type of device for generating output to a human or machine.

Computing device 116 and mobile computing device 110 include application modules 124A and 124B, respectively. Application modules 124A and 124B (collectively, application modules 124) represent all the various individual applications and services that may be executing at computing device 116 or mobile computing device 110 at any given time. Numerous examples of application modules 124 exist, including a mapping or navigation application, a calendar application, a personal assistant or prediction engine, a search application, a transportation service application (e.g., a bus or train tracking application), a social media application, a game application, an e-mail application, a messaging application, an Internet browser application, or any and all other applications that may execute at a computing device.

Computing device 116 and mobile computing device 110 include audio testing modules 122A and 122B, respectively. Audio testing modules 122A and 122B (collectively, audio testing modules 122) are configured to test audio output capabilities of computing device 116 and/or mobile computing device 110. Assistant modules 126A and 126B (collectively, assistant modules 126) are configured to manage user interactions with application modules 124 and provide information to a user of computing device 116 or mobile computing device 110. For example, assistant modules 126 may execute one of application modules 124, such as a music application or a telephone application, in response to a query or a command from the user, such as a command to “Play Music” or “Call Dad.”

Modules 122, 124, and 126 may perform operations described using hardware, hardware and firmware, hardware and software, or a mixture of hardware, software, and firmware residing in and/or executing at computing device 116 and/or 110. Computing devices 116, 110 may execute modules 122, 124, and 126 with multiple processors or multiple devices. Computing devices 116, 110 may execute modules 122, 124, and 126 as virtual machines executing on underlying hardware. Modules 122, 124, and 126 may execute as one or more services of an operating system or computing platform. Modules 122, 124, and 126 may execute as one or more executable programs at an application layer of a computing platform.

In accordance with techniques of this disclosure, one or both of audio testing modules 122 (e.g., audio testing module 122B of mobile computing device 110) may test the audio output capabilities of computing device 116 and/or mobile computing device 110. In some examples, mobile computing device 110 outputs a command to computing device 116 to cause computing device 116 to output test audio data. In other words, the command includes data causing computing device 116 to playback the test audio data. The command may include the test audio data, such as data indicative of a tone, word, phrase, song, or other sound. In one example, mobile computing device 110 may store test audio data locally or may stream test audio data from another computing device (e.g., a cloud computing system, such as a subscription music service). Additionally or alternatively to including test audio data, the command may include, in some scenarios, data identifying the test audio data. For example, the command to output test audio data may include a file name of the test audio data (e.g., stored on computing device 116 or a cloud computing system) or a uniform resource locator (URL) indicating the address of the test audio data.

Computing device 116 outputs test audio data via one or more UIDs 112A (e.g., speakers) in response to receiving the command from mobile computing device 110. For example, computing device 116 may output test audio data received from mobile computing device 110. In another example, computing device 116 may retrieve the test audio data from memory or another computing device based on the filename, URL, or other identifier or address of the test audio data indicated by the command. According to some scenarios, computing device 116 outputs the test audio data to one or more UIDs, such as a speaker.

One or more UIDs 112A of computing device 116 emits an audio signal that encodes the test audio data. Additionally or alternatively, in some examples, UIDs 112B of mobile computing device 110 emit an audio signal that encodes the test audio data. In some examples, a frequency of the audio signal that encodes the test audio data is within a human audible frequency range (e.g., between approximately 20 Hz and approximately 20 kHz). In another example, the frequency of the audio signal that encodes the test audio data may be greater than a threshold frequency (e.g., approximately 20 kHz). For example, the threshold frequency may be above the human audible range (e.g., above approximately 20 kHz). In other words, the audio signal that encodes the test audio data may be an ultrasonic signal. The frequency of the audio signal that encodes the test data may be selected by the mobile computing device 110 or computing device 116 based on frequencies and/or amplitudes of background/ambient noise in the environment of the device(s) 110, 116.

In some examples, mobile computing device 110 and/or computing device 116 repeatedly outputs test audio data. For example, audio testing module 122B may periodically transmit the test audio data to computing device 116 in pre-determined intervals (e.g., once every 30 seconds, every minute, every five minutes, etc.). As another example, audio testing module 122B may transmit the test audio data in response to a triggering event, such as detecting a person in proximity to mobile computing device 110 (e.g., via a proximity sensor, an audio input device, an imaging device, etc.).

Throughout the disclosure, examples are described where a computing device and/or a computing system analyzes information (e.g., audio data captured by a microphone) associated with a computing device and a user of a computing device, only if the computing device receives permission from the user of the computing device to analyze the information. For example, in situations discussed below, before a computing device or computing system can collect or may make use of information associated with a user, the user may be provided with an opportunity to provide input to control whether programs or features of the computing device and/or computing system can collect and make use of user information (e.g., information about a user's current location, current speed, etc.), or to dictate whether and/or how to the device and/or system may receive content that may be relevant to the user. In addition, certain information may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device and computing system.

Audio testing module 122B determines whether the test audio data was detected by an audio input device, such as one of UIDs 112B (e.g., a microphone) of mobile computing device 110 and/or one of UIDs 112A of computing device 116. In other words, audio testing module 122B determines whether one of UIDs 112 detected an audio signal that encodes the test audio data. In some scenarios, UIDs 112B detects or captures audio signals within the environment (e.g., within a cabin of a vehicle, within a room, etc.) and outputs audio data encoded in the captured audio signals to audio testing module 122B. In another scenario, UIDs 112A detect the audio signals within the environment and outputs audio data encoded in the audio signals to audio testing module 122B. Audio testing module 122B may compare the data received from UIDs 112A and/or 112B to the test audio data. For example, audio testing module 122B may compare a fingerprint of the audio data encoded in the captured audio signals to the test audio data to determine whether the captured audio data includes the test audio data.

In some examples, audio testing module 122B determines the test audio data was detected in response to determining that the audio signals captured by UIDs 112 include the test audio data. In response to determining the test audio data was detected by the audio input device, mobile computing device 110 performs one or more actions. As one example, mobile computing device 110 may execute one of application modules 124B, such as a sound application (e.g., a music application, an audiobook application, etc.) or an assistant application. In one example, mobile computing device 110 executes the sound application and transmits application audio data (e.g., a song, a podcast, an audiobook, etc.) to computing device 116. As another example, an assistant application may detect spoken audio commands spoken by a user of mobile computing device 110 or computing device 116. In the example of FIG. 1, mobile computing device 110 may output advisory audio data indicating that one or more audio input devices are ready to receive a spoken audio command (e.g., by capturing audio data spoken by a user of computing devices 116, 110). For example, the advisory audio data may include a chime, ding, or other sound that indicates that mobile computing device 110 and/or computing device 116 are ready to receive a spoken audio command. Outputting the advisory audio data may inform a user of computing device 116 and/or mobile computing device 110 that computing device 116 and/or mobile computing device 110 is ready to receive voice commands.

Computing device 116 may receive an audio command spoken by a user of mobile computing device 110 and/or computing device 116. For example, computing device 116 may receive user audio data that includes a spoken command from one of UIDs 112A or 112B. In some examples, assistant module 126B processes the user audio data (e.g., by performing speech recognition) to determine or identify one or more commands included in the user audio data. As one example, assistant module 126B may determine the user audio data includes a command to make a call or navigate to a destination. In such examples, assistant module 126B may execute one of application modules 124 associated with the command. For example, assistant module 126B may execute a phone application and cause the phone application to make a call or execute a navigation application and cause the navigation application to provide directions to the destination.

Audio testing module 122B determines, in some scenarios, that the test audio data was not detected by an audio input device in response to determining that the captured audio data does not include the test audio data. Responsive to determining that the test audio data was not detected, in some scenarios, mobile computing device 110 performs one or more actions.

Mobile computing device 110 may, in some instances, perform an action by outputting a second command to cause computing device 116 to attempt to re-output the test audio data. For example, audio testing module 122B of computing device 110 may periodically (e.g., every 30 seconds, every 2 minutes, etc.) re-output the test audio data and determine whether the test audio was detected by computing device 116 and/or mobile computing device 110. In one example, the second command includes a command to increase the volume of the speaker of computing device 116. In another example, audio testing module 122B outputs additional commands that cause the speakers to successively increase the volume of the test audio data up to a threshold volume.

In one example, mobile computing device 110 performs an action by outputting a notification indicating that the test audio data was not detected. For example, audio testing module 122B may output the notification to computing device 116 for display via one of UIDs 112A. In one example, the notification indicates that assistant modules 126 are temporarily unavailable and/or that application audio data will not be transmitted from mobile computing device 110 to computing device 116 (e.g., to alert the user of an error). In one example, the notification includes a recommendation to increase the volume of UID 112A. In another example, the notification includes data indicating other recommendations, such a recommendation to submit a bug report, re-send the test audio data, among other recommendations. In such examples, computing device 116 may output GUI 132 in response to receiving the notification. Audio testing module 122B may, in some scenarios, output a bug report to another computing device (e.g., to a manufacturer of computing device 116 or mobile computing device 110) indicating the test audio data was not detected.

In some examples, mobile computing device 110 refrains from performing an action in response to determining that the test audio data was not detected. For example, audio testing module 122B of mobile computing device 110 may temporarily refrain from outputting application audio data to computing device 116. For instance, audio testing module 122B may temporarily prevent a music application from sending music data to computing device 116 for playback via a speaker of computing device 116 until audio testing module 122B determines that the test audio data is detected (e.g., hence, was successfully output by the speakers of computing device 116). In this way, mobile computing device 110 may reduce network traffic between mobile computing device 110 and computing device 116 by refraining from transmitting audio data when data packets are likely to be dropped or, for example, the volume is too low to be heard by the user. Further, refraining from outputting the application audio data when packets are likely to be dropped or, for example, the volume is too low to be heard, may improve the user experience by, for example, refraining from playing only parts of a song.

In another example, mobile computing device 110 temporarily refrains from outputting advisory audio data and may refrain from executing assistant module 126B in response to determining that the test audio data was not detected. Refraining from outputting the advisory audio data and executing assistant module 126B when packets are likely to be dropped, or for example, the volume is too low to be heard may improve the user experience by, for example, refraining from triggering assistant module 126 and processing voice commands when the user is not likely to hear the advisory audio data (e.g., and thus be unaware that the assistant module 126 is listening for a command). Further, refraining from processing voice commands when the user is unaware that assistant module 126 is listening may reduce the number of computations performed by mobile computing device 110 or another computing device. In this way, mobile computing device 110 may refrain from processing voice commands and executing actions (e.g., outputting audio data) based on the user's voice commands until audio testing module 122B determines that UIDs 112 have detected the test audio data and hence that UIDs 112 are successfully outputting audio data.

While audio testing module 122B and assistant module 126B are described as performing techniques of this disclosure, audio testing module 122A and/or assistant module 126A may perform all or part of the functionality associated with audio testing module 122B and assistant module 126B. For example, audio testing module 122A may determine whether an audio input device detects the test audio data and/or assistant module 126A may process audio commands or execute actions based on the commands.

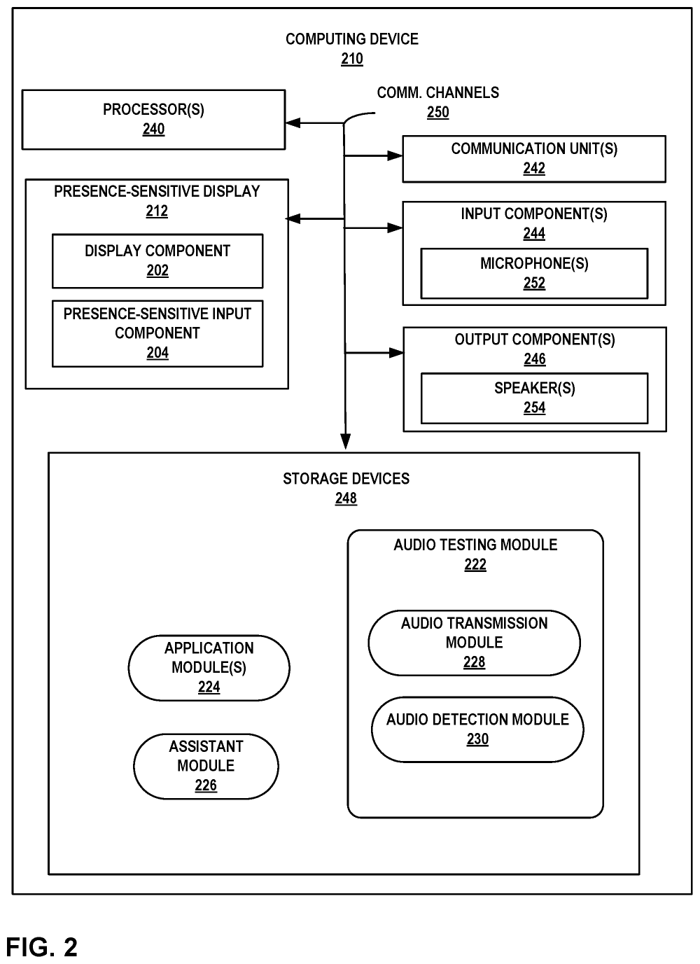

FIG. 2 is a block diagram illustrating an example computing device that is configured to perform audio testing, in accordance with one or more aspects of the present disclosure. Computing device 210 of FIG. 2 is described below as an example of mobile computing device 110 illustrated in FIG. 1. In another example, computing device 210 may be an example of computing device 116 of FIG. 1. FIG. 2 illustrates only one particular example of a computing device. Many other examples of a computing device may be used in other instances, which may include a subset of the components included in example of FIG. 2 or may include additional components not shown in FIG. 2.

As shown in the example of FIG. 2, computing device 210 includes presence-sensitive device (PSD) 212, one or more processors 240, one or more communication units 242, one or more input components 244, one or more output components 246, and one or more storage components 248. PSD 212 includes display component 202 and presence-sensitive input component 204. Storage components 248 of computing device 210 may include an audio testing module 222, one or more application modules 224, and an assistant module 226. In the example of FIG. 2, audio testing module 222 includes audio transmission module 228 and audio detection module 230. Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios (e.g., WIFI, WIFI Direct, BLUETOOTH, NFC, etc.), as well as universal serial bus (USB) controllers.

One or more input components 244 of computing device 210 may receive input. Examples of input are tactile, audio, and video input. Input components 244 of computing device 210, in one example, includes a presence-sensitive input device (e.g., a touch sensitive screen, a PSD), mouse, keyboard, voice responsive system, video camera, microphone(s) 252, or any other type of device for detecting input from a human or machine.

One or more output components 246 of computing device 210 may generate output. Examples of output are tactile, audio, and video output. Output components 246 of computing device 210, in one example, includes a PSD, sound card, speaker(s) 254, liquid crystal display (LCD), light emitting diode (LED) display, or any other type of device for generating output to a human or machine.

PSD 212 of computing device 210 includes display component 202 and presence-sensitive input component 204. Display component 202 may be a screen at which information is displayed by PSD 212 and presence-sensitive input component 204 may detect an object at and/or near display component 202. As one example range, presence-sensitive input component 204 may detect an object, such as a finger or stylus that is within two inches or less of display component 202. Presence-sensitive input component 204 may determine a location (e.g., an [x, y] coordinate) of display component 202 at which the object was detected. In another example range, presence-sensitive input component 204 may detect an object six inches or less from display component 202 and other ranges are also possible. Presence-sensitive input component 204 may determine the location of display component 202 selected by a user's finger using radar, capacitive, inductive, and/or optical recognition techniques. In some examples, presence-sensitive input component 204 also provides output to a user using tactile, audio, or video stimuli as described with respect to display component 202.

One or more processors 240 may implement functionality and/or execute instructions associated with computing device 210. Examples of processors 240 include application processors, display controllers, auxiliary processors, one or more sensor hubs, and any other hardware configured to function as a processor, a processing unit, or a processing device. Modules 222, 224, and 226 may be operable by processors 240 to perform various actions, operations, or functions of computing device 210. For example, processors 240 of computing device 210 may retrieve and execute instructions stored by storage components 248 that cause processors 240 to perform the operations of modules 222, 224, and 226. The instructions, when executed by processors 240, may cause computing device 210 to store information within storage components 248.

One or more storage components 248 within computing device 210 may store information for processing during operation of computing device 210 (e.g., computing device 210 may store data accessed by modules 222, 224, 226 during execution at computing device 210). In some examples, storage component 248 is a temporary memory, meaning that a primary purpose of storage component 248 is not long-term storage. Storage components 248 of computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories. Storage components 248 may store program instructions and/or information (e.g., data) associated with modules 222, 224, and 226. Storage components 248 may include a memory configured to store data or other information associated with modules 222, 224, and 226.

Application modules 224 represent all the various individual applications and services executing at and accessible from computing device 210. Application modules 224 may include the functionality of application module 124 of FIG. 1. Examples of application modules 224 include a mapping or navigation application, a calendar application, a personal assistant or prediction engine, a search application, a transportation service application (e.g., a bus or train tracking application), a social media application, a game application, an e-mail application, a messaging application, an Internet browser application, or any and all other applications that may execute at a computing device. Application modules 224 may be configured to output application audio data for playback via one or more speakers 254. As used herein, application audio data includes any data that may be consumed by a user of the application, such as a song, a podcast, an audiobook, navigation directions, weather information, calendar information, among others.

According to some techniques of this disclosure, audio transmission module 228 tests the audio output capabilities of a different computing device by transmitting test audio data to the different computing device for playback via one or more speakers of the different computing device. Audio transmission module 228 may transmit the test audio data via a wireless or wired communication unit 242. In another example, audio transmission module 228 tests the audio output capabilities of computing device 210 by outputting test audio data via speakers 254.

In some scenarios, audio transmission module 228 outputs a first portion of test audio data in response to establishing communication with the computing device. As one example, computing device 210 may establish a direct communication connection with computing device 116 of FIG. 1, such as a vehicle head unit, when computing device 210 is in proximity to the computing device 116. For example, computing device 210 may wirelessly communicate with computing device 116 when computing device 210 and computing device 116 are within a threshold distance of one another.

In some examples, audio transmission module 228 causes the speaker to output the first portion of the test audio data within a human audible frequency range (e.g., between approximately 30 Hz and approximately 20 kHz). As one example, audio testing module 222 may cause the speaker to output the first portion of the test audio data over a range of different frequencies. The first portion of the test audio data may include a plurality of messages, where each message of the plurality of messages is associated with a frequency of the range of frequencies. For example, the first portion of the audio test data may include a first message to be output by a speaker at a first frequency (e.g., 1 kHz), a second (e.g., different) message to be output by the speaker at a second frequency (e.g., 2 kHz), and so on. Audio transmission module 228 may output a command to computing device 116 to cause a speaker of computing device 116 to output the first portion of the test audio data. In other words, audio transmission module 228 may cause the speaker of computing device 116 to encode the first message into a first audio signal having a first frequency and encode the second message into a second audio signal having a second frequency, and so on. In this way, the speaker of computing device 116 may encode each message of the first portion of the test audio data into a respective audio signal having a respective frequency associated with the message. In yet another example, audio transmission module 228 causes speakers 254 to output each message of the first portion of the test audio data. In one instance, audio transmission module 228 causes the speaker to encode the test audio data based on frequency-shift keying (FSK) techniques.

Audio detection module 230 may determine whether each message of the plurality of messages is detected by an input component 244 (e.g., a speaker) of computing device 210 and/or a speaker of computing device 116. In some instances, UID 112B of computing device 116 detects or captures audio signals within the environment (e.g., within a cabin of a vehicle that includes computing device 116) and outputs the audio data encoded in the captured audio signals to audio detection module 230. In another example, microphone 252 detects the audio signals in the environment and outputs the captured audio data to audio detection module 230. Audio detection module 230 may compare the data received from UID 112B and/or microphone 252 to the first portion of the test audio data. For example, audio detection module 230 may compare a fingerprint of the audio data encoded in the captured audio signals to the test audio data to determine whether the captured audio data includes each message of the first portion of the test audio data.

Audio detection module 230 may determine that an error occurred in the playback of the first portion of the test audio data in response to determining that the received audio data does not include each message of the first portion of the test audio data. As one example, audio detection module 230 may determine which particular message or messages were not included in the audio data received from UID 112B and/or microphone 252. For example, audio detection module 230 may infer that the speaker malfunctioned (e.g., is unable to output audio signals above a threshold frequency associated with the message that was not received) or that a data packet that included the particular message was dropped.

Audio detection module 230 may determine a cause of the error in the playback of the first portion of the audio data. For example, audio detection module 230 may determine the cause of the error by re-outputting the first portion of the test audio data in response to detecting the error. In one example, audio detection module 230 re-outputs all of the first portion of the test audio data. In another example, audio detection module 230 re-outputs a sub-portion of the first portion of the audio test data. For example, the sub-portion may include the particular message which was not detected in the audio data received from UID 112B of computing device 116 or from microphone 252. For example, audio detection module 230 may determine the error is a malfunction of UID 112B in response to determining that the particular message was not detected even after re-outputting the particular message to computing device 116. In another example, audio detection module 230 may determine the error was caused by a dropped packet in response to determining that the particular message was detected by a microphone of computing device 116 or microphone 252 of computing device 210 after re-outputting the particular message. In this way, audio detection module 230 may test the connection (e.g., wireless connection) between computing device 210 and computing device 116 as well as test the operation of UID 112B of computing device 116. In another example, audio detection module 230 determines the error was caused by a fault with the computing device 116 (e.g., rather than a transmission error such as a dropped packet) in response to receiving a message from computing device 116 acknowledging the command from computing device 210.

Audio detection module 230 may output a notification indicating the error. In one example, the notification includes data indicating which particular message was not received. In another example, the notification includes data indicating the determined cause of the error. In yet another example, the notification includes data indicating one or more recommended actions, such as submitting a bug report, re-sending a command that includes the test audio data, etc.

In one scenario, audio transmission module 228 outputs a command to cause computing device 116 to playback a second portion of the test audio data via one or more speakers of output components 246 of computing device 210. The command may include the second portion of the test audio data, such as data indicative of a tone, word, phrase, song, or other sound. In one example, the command includes data identifying the second portion of the test audio data, such as a file name of the second portion of the test audio data (e.g., stored on computing device 116 or a cloud computing system) or a uniform resource locator (URL) indicating the address of the second portion of the test audio data. In another example, audio transmission module 228 outputs the second portion of the test audio data via speakers 254 of computing device 210.

In some examples, the command indicates one or more characteristics of the second portion of the test audio data. Example characteristics of the audio include the frequency or frequencies of the audio, amplitude, or intensity of the audio, among others. Audio transmission module 228 may determine characteristics of the second portion of the test audio data based at least in part on the characteristics of ambient audio within the environment in which computing device 210 is located. For example, audio transmission module 228 may receive audio data indicating of the ambient audio from microphone 252 of input components 244 of computing device 210 or from another computing device within the environment, such as computing device 116 (e.g., a vehicle head unit).

Audio transmission module 228 may assign a frequency to the second portion of the test audio data. In one example, the frequency assigned to the second portion of the test audio data is an ultrasonic frequency, such as a frequency above a human audible range (e.g., at least approximately 20 kHz). Additionally or alternatively, in one example, audio transmission module 228 determines or assigns a frequency of the second portion of the test audio data based on the frequencies of the ambient audio. For example, audio transmission module 228 may determine harmonic frequencies of the frequencies of the ambient audio. As one example, audio transmission module 228 may determine one or more reference frequencies of the ambient audio signals where the amplitude of the ambient audio is at least a threshold amplitude. In other words, in one example, the reference frequencies include one or more frequencies at which the amplitude of the ambient audio is louder than a threshold level. Audio transmission module 228, in some instances, assigns a frequency to the second portion of the test audio data such that the assigned frequency is not a harmonic of the reference frequencies. By assigning a frequency to the second portion of the audio data that is shifted from the harmonic frequencies of the reference frequencies, audio transmission module 228 may increase the likelihood that the second portion of the test audio data will be distinguishable from the ambient audio when the second portion of the test audio data is output by one or more speakers.

In some examples, audio transmission module 228 may re-output the second portion of the test audio data. For example, audio transmission module 228 may periodically transmit the second portion of the test audio data to computing device 116 in pre-determined intervals (e.g., once every 30 seconds, every minute, every five minutes, etc.). As another example, audio transmission module 228 may transmit the second portion of the test audio data in response to a triggering event, such as detecting a person in proximity to computing device 210 (e.g., via a proximity sensor, an audio input device, an imaging device, etc.).

After sending a command to cause computing device 116 to output the second portion of the test audio data, audio detection module 230 determines whether audio captured by an audio input device (such as microphone 252 of computing device 210 and/or a microphone of computing device 116) includes the second portion of the test audio data. For example, audio detection module 230 may receive audio data from a microphone of a vehicle that includes computing device 116 or microphone 252 of input components 244 of computing device 210. In other words, audio detection module 230 determines whether computing device 116 and/or computing device 210 detected an audio signal that encodes the second portion of the test audio data. In one example, audio detection module 230 compares a fingerprint of the audio data encoded in the captured audio signals to the second portion of the test audio data to determine whether the captured audio data includes the second portion of the test audio data.

In some examples, audio detection module 230 determines the second portion of the test audio data was detected in response to determining that the audio signals captured by the input component (e.g. UID 112B of computing device 116 and/or input components 244 of computing device 210) includes the second portion of the test audio data. In other words, audio detection module 230 determines whether the audio captured by the audio input device includes the second portion of the test audio data. Computing device 210 performs one or more actions in response to determining the second portion of the test audio data was detected by the audio input device. As one example, computing device 210 may execute one of application modules 224, such as a sound application (e.g., a music application, an audiobook application, etc.). For example, computing device 210 executes the sound application and transmits application audio data (e.g., a song, a podcast, an audiobook, etc.) to computing device 116.

As another example, responsive to determining that captured audio includes the second portion of the test audio data, assistant module 226 may analyze audio input from the microphone to determine whether the audio input includes a spoken hotword or audio trigger (e.g., “hey computer” or “OK computer”) indicating a request to process a spoken audio command. In response to determining that the audio input includes spoken audio input including the hotword, assistant module 226 may output advisory audio data for playback via a speaker of computing device 116 and/or computing device 210. In some examples, the advisory audio data indicates that one or more audio input devices are ready to receive a spoken audio command. In other words, the advisory audio data indicates that assistant module 226 will analyze the audio input data to determine whether the audio input data includes a spoken audio command. Assistant module 226 may output a command that includes the advisory audio data and that causes the speaker to output an audio signal that encodes the advisory audio data within a human audible frequency range (e.g., between approximately 20 Hz and approximately 20 kHz). In this way, if computing device 210 determines that the captured audio includes the second portion of the test audio data (and hence, that the speaker successfully output the second portion of the test audio data), computing device 210 may infer that the quality of a wireless connection between computing device 116 and computing device 210 is sufficient to transfer audio data to the computing device 116 and that the volume of sound output by a speaker of computing device 116 is loud enough to be heard by the user. In such situations, a user of computing device 210 is more likely to hear advisory audio data after the user speaks a hotword, such that the user is more likely to be aware computing device 210 is processing input audio for spoken audio commands.

Assistant module 226 may process spoken audio input, also referred to as user audio data, to determine whether the spoken audio input includes a command. In some examples, assistant module 226 processes the user audio data (e.g., by performing speech recognition) to determine or identify one or more commands included in the user audio data. As one example, assistant module 226 may determine the user audio data includes a command to navigate to a destination. In such examples, assistant module 226 may execute one of application modules 224 that is associated with the command, such as a navigation application module 224. Navigation application module 224, in some examples, outputs navigation data to computing device 116 (e.g., a vehicle computing device) to cause computing device 116 to display the navigation data.

According to some scenarios, audio detection module 230 determines that the captured audio data does not include the second portion of the test audio data. In other words, audio detection module 230 may determine that an error occurred in the playback of the second portion of the test audio data. Responsive to determining that an error occurred (e.g., that the second portion of the audio was not detected), computing device 210 performs one or more actions.

In some examples, audio detection module 230 performs an action by sending a second command to cause computing device 116 to re-output the second portion of the test audio data. For example, computing device 210 may periodically (e.g., every 30 seconds, every 2 minutes, etc.) re-output the second portion of the test audio data and determine whether the second portion of the test audio data was detected by computing device 116 and/or audio detection module 230. In one example, the second command includes a command to increase the volume of the speaker of computing device 116. In another example, audio detection module 230 may output additional commands that cause the speakers to successively increase the volume of the second portion of the test audio data (e.g., by increasing the amplitude of the signal that encodes the second portion of the test audio data) up to a threshold volume.

Audio detection module 230 may, in some scenarios, perform an action by determining a cause of the error in the playback of the second portion of the test audio data. In one example, audio detection module 230 may determine that the error was caused by data loss (e.g., a dropped packet, over writing a packet in a buffer of computing device 116, etc.) in response to determining that the second portion of the audio data was detected after sending a command to re-output the second portion of the test audio data. In another example, audio detection module 230 determines that the error was caused by having the volume too low in response to determining that the second portion of the test audio data was detected after sending a command to re-output the second portion of the test audio data at a higher volume.

In some examples, audio detection module 230 performs an action by outputting data indicating a potential cause of the error. For example, audio detection module 230 may output notification via PSD 212 and/or send the notification to computing device 116 for output via a display of computing device 116. The notification may include data indicating a possible cause of the error or the determined cause of the error. In some instances, audio detection module 230 outputs a bug report to another computing device (e.g., to a manufacturer of computing device 116 or computing device 210) indicating the second portion of the test audio data was not detected.

According to some examples, computing device 210 refrains from performing an action in response to determining that the second portion of the test audio data was not detected. For example, audio detection module 230 may cause application modules 224 to temporarily refrain from outputting application audio data to computing device 116 (e.g., until determining the test audio data is detected). In this way, computing device 210 may reduce network traffic between computing device 210 and computing device 116 by refraining from transmitting audio data when data packets are likely to be dropped, or for example, the volume is too low to be heard by the user. Further, refraining from outputting the application audio data when packets are likely to be dropped, or for example, when the volume is too low to be heard may improve the user experience by, for example, refraining from playing only parts of a song.

In another example, audio detection module 230 causes computing device 210 to temporarily refrain from outputting advisory audio data and executing assistant module 226 in response to determining that the second portion of the test audio data was not detected. Refraining from outputting the advisory audio data and executing assistant module 226 when packets are likely to be dropped or, for example, when the volume is too low to be heard may improve the user experience by, for example, refraining from triggering assistant module 126 and processing voice commands when the user is not likely to hear the advisory audio data (e.g., and thus be unaware that the assistant module 126 is listening for a command). Further, refraining from processing voice commands when the user is unaware that assistant module 126 is listening may prevent or reduce the number of unnecessary computations performed by computing device 210 or another computing device. In this way, computing device 210 may refrain from processing voice commands and executing actions (e.g., outputting audio data) based on the user's voice commands until audio testing module 122B determines that UIDs 112 have detected the second portion of the test audio data and hence that UIDs 112 are successfully outputting audio data.

While described as outputting data to computing device 116, in some examples, audio testing module 222 may perform a self-test of speakers 254 of computing device 210. For example, audio testing module 222 may output the test audio data via speakers 254. Audio testing module 222 may determine whether the test audio data was detected by microphone 252 of computing device 210 or a microphone of a different computing device (e.g., computing device 116 of FIG. 1, such as a computing device in a vehicle). For example, the different computing device may include a microphone to detect audio and audio testing module 222 may receive audio data from the different computing device. In such examples, audio testing module 222 may determine whether the audio data detected by the different computing device includes the test audio data. In another example, audio testing module 222 determines whether audio detected by microphone 252 of computing device 210 includes the audio data. In this way, audio testing module 222 may detect issues in playing audio via speakers 254, such as having the volume turned down too low, a speaker malfunction, etc.

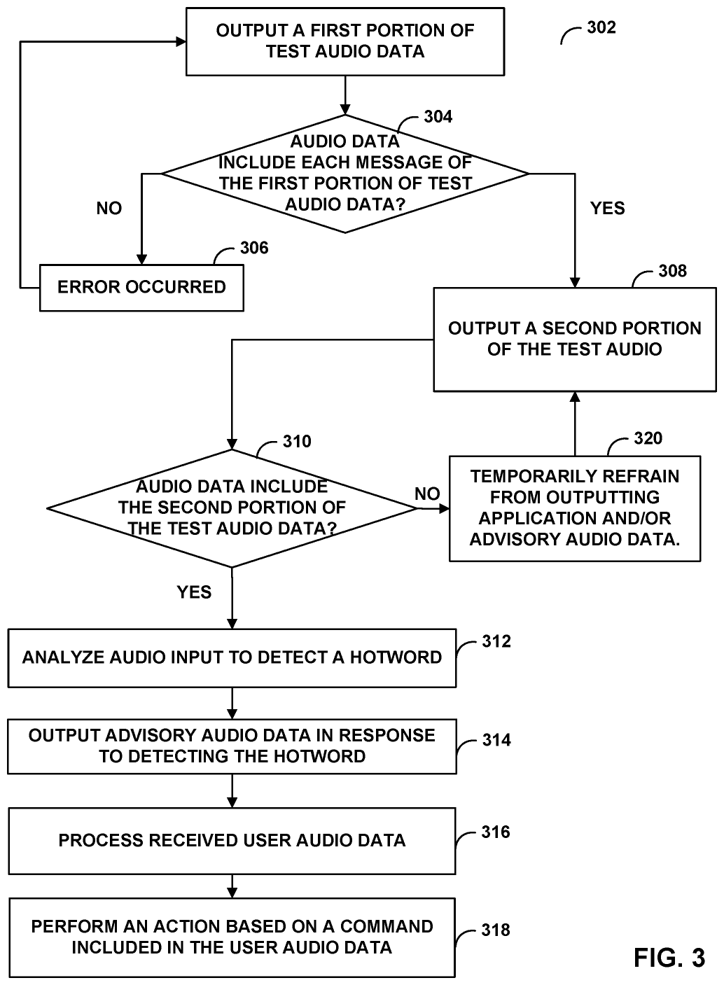

FIG. 3 is a flowchart illustrating example operations of a computing device that is configured to perform audio testing, in accordance with one or more aspects of the present disclosure. For purposes of illustration only, FIG. 3 is described below within the context of system 102 of FIG. 1.

In the example of FIG. 3, audio testing module 122B of mobile computing device 110 outputs a first portion of test audio data (302). In one example, audio testing module 122B outputs the first portion of the test audio via a UID 112A of computing device 110. In another example, audio testing module 112B outputs the first portion of the test audio data to computing device 116 for playback via a speaker of a computing device 116 (302). Mobile computing device 110 and computing device 116 may be communicatively coupled via a wired and/or wireless connection. In one example, mobile computing device 110 is directly communicatively coupled to computing device 116 via a direct wireless connection (e.g., without communicating through a router or other network device, for example, via WIFI, WIFI Direct, or BLUETOOTH). In another example, mobile computing device 110 is communicatively coupled to computing device 116 via another device, such as a router or other computing device (e.g., via a mesh network). In some examples, audio testing module 122B of mobile computing device 110 causes the speaker of computing device 116 to output the first portion of the test audio data within a human audible frequency range (e.g., between approximately 30 Hz and approximately 20 kHz). The first portion of the test audio data may include a plurality of messages, where each message of the plurality of messages is associated with a frequency of the range of frequencies. As one example, audio testing module 122B may cause the speaker to output each message of the plurality of messages at a respective frequency in the range or plurality of frequencies. In other words, audio testing module 122B may cause a speaker to encode the first message into a first audio signal having a first frequency and encode the second message into a second audio signal having a second frequency, and so on. Audio testing module 122B may cause the speaker to output an audio signal that encodes the first portion of the test audio data within a human audible frequency range (e.g., between approximately 20 Hz and approximately 20 kHz).

Audio testing module 122B may receive audio data from a microphone, such as a microphone of mobile computing device 110 and/or computing device 116. Audio testing module 122B may determine whether the audio data includes each message of the plurality of messages (304). For example, audio testing module 122B may compare a fingerprint of the audio data encoded in the captured audio signals to the test audio data to determine whether the captured audio data includes each message of the first portion of the test audio data.

In one scenario, audio testing module 122B may determine that an error occurred in the playback of the first portion of the test audio data (306) in response to determining that the received audio data does not include each message of the first portion of the test audio data (“NO” branch of 304). In one example, audio testing module 122B re-outputs at least part (e.g., all or a sub-portion) of the first portion of the test audio data in response to detecting the error (302).

Audio testing module 122B outputs a second portion of the test audio data (308). Audio testing module 122B may output the second portion of the test audio data via UIDs 112A of mobile computing device 110. In another example, audio testing module 112B outputs a command to computing device 116 that causes computing device 116 to output the second portion of the test audio data via a speaker (e.g., UID 112A) of computing device 116 (308). The command may include the second portion of the test audio data and/or data identifying the second portion of the test audio data. In some examples, the command indicates one or more characteristics of the second portion of the test audio data. The command may include data causing the speaker to output an audio signal that encodes the second portion of the test audio data at a frequency above a threshold frequency associated with human hearing (e.g., approximately 20 kHz). In other words, the command may cause the speaker to output the second portion of the test audio data via an ultrasonic audio signal.

In one scenario, audio testing module 122B determines whether audio captured by an audio input device (e.g., a microphone) includes the second portion of the test audio data (310). For example, audio testing module 122B may receive audio data from a UID 112B of computing device 116 or a UID 112A of mobile computing device 110. Audio testing module 122B determines whether the audio data includes the test audio data, for example, by comparing a fingerprint of the audio data encoded in the captured audio signals to the second portion of the test audio data. In some examples, audio testing module 122B determines the captured audio includes the second portion of the test audio data (“YES” branch of 310).

Mobile computing device 110 performs one or more actions in response to determining that the audio captured by the audio input device includes the second portion of the test audio data. As one example, mobile computing device 110 may execute one of application modules 124B, such as a sound application (e.g., a music application, an audiobook application, etc.). In such examples, mobile computing device 110 may execute the sound application and transmits application audio data (e.g., a song, a podcast, an audiobook, etc.) to computing device 116.

In the example of FIG. 3, assistant module 126B analyze audio input from UIDs 112 to determine whether the audio input includes a spoken hotword or audio trigger (e.g., “hey computer” or “OK computer”) indicating a request to process a spoken audio command (312). For example, assistant module 126B may perform speech recognition on the audio input (e.g., locally or by sending the audio data to a cloud-based computing device) to determine whether the audio input includes the hotword.

Assistant module 126B outputs advisory audio data for playback via a speaker of computing device 116 and/or mobile computing device 110 in response to determining that the audio input includes spoken audio input including the hotword (314). For example, assistant module 226 may output a command to computing device 116 to cause UID 112A to playback the advisory audio data via a speaker of the computing device 116. The command may also include data causing the speaker to output an audio signal that encodes the advisory audio data within a human audible frequency range (e.g., between approximately 20 Hz and approximately 20 kHz).

Assistant module 126B may process user audio data in response to detecting the hotword to determine whether the user audio data includes a command (316). In some examples, assistant module 226 processes the user audio data (e.g., by performing speech recognition locally or via a cloud-based device) to determine or identify one or more commands included in the user audio data. For example, assistant module 226 may determine the user audio data includes a command to navigate to a destination.

In one example, assistant module 126B performs an action based on the command included in the user audio data (318). For example, assistant module 226 may execute one of application modules 224 that is associated with the command, such as a navigation application module 224, an audio application (e.g., a music application, an audiobook application, etc.), a calendar application, or any other application.

According to some scenarios, audio testing module 122B determines that the audio captured by the audio input device does not include the second portion of the test audio data (“NO” branch of 310) in response to determining that the captured audio data does not include the second portion of the test audio data. Responsive to determining that the second portion of the audio was not detected, mobile computing device 110 performs one or more actions, refrains from performing one or more different actions, or both.

According to some examples, mobile computing device 110 temporarily refrains from outputting application audio data and/or from outputting advisory audio data (320). For example, audio testing module 122B may cause mobile computing device 110 to temporarily refrain from outputting advisory audio data and executing assistant module 226 in response to determining that the second portion of the test audio data was not detected. Refraining from outputting the advisory audio data and executing assistant module 226 when packets are likely to be dropped, or for example, the volume is too low to be heard may improve the user experience by, for example, refraining from triggering assistant module 126 and processing voice commands when the user is not likely to hear the advisory audio data (e.g., and thus be unaware that the assistant module 126 is listening for a command). Further, refraining from processing voice command when the user is unaware that assistant module 126 is listening may reduce the number of unnecessary and/or duplicate computations performed by mobile computing device 110 or another computing device. In this way, mobile computing device 110 may refrain from processing voice commands and executing actions (e.g., outputting audio data) based on the user's voice commands until audio testing module 122B determines that UIDs 112 have detected the second portion of the test audio data and hence that UIDs 112 are successfully outputting audio data.

In some examples, audio testing module 122B performs an action by re-outputting the second portion of the test audio data (308). For example, audio testing module 122B may send another command to computing device 116 to cause computing device 116 to re-output the second portion of the test audio data (308). For example, computing device 110 may periodically (e.g., every 30 seconds, every 2 minutes, etc.) re-output the second portion of the test audio data and determine whether the second portion of the test audio data was detected by computing device 116 and/or audio testing module 122B. In one example, the second command includes a command to increase the volume of the speaker. In another example, audio testing module 122B may output additional commands that cause the speakers to successively increase the volume of the second portion of the test audio data (e.g., by increasing the amplitude of the signal that encodes the second portion of the test audio data) up to a threshold volume.

The following numbered examples may illustrate one or more aspects of the disclosure:

Example 1. A method comprising: outputting, by a computing device, test audio data; determining, by the computing device, whether audio data detected by an audio input device includes the test audio data; and responsive to determining that the test audio data was not detected by the audio input device, temporarily refraining, by the computing device, from outputting advisory audio data indicating the audio input device is ready to receive a spoken audio command

Example 2. The method of example 1, wherein outputting the test audio data includes outputting the test audio data via one or more speakers of the computing device.

Example 3. The method of example 1, wherein outputting the test audio data comprises outputting, by the computing device, to a different computing device for output via one or more speakers of the different computing device, the test audio data.

Example 4. The method of example 3, further comprising: receiving the audio data from a first audio input device included in the computing device or from a second audio input device included in the vehicle.

Example 5. The method of example 1, further comprising: outputting, by the computing device, for display by a display device, a notification indicating that the test audio data was not detected in response to determining that the audio detected by the audio input device did not include the test audio data.

Example 6. The method of example 1, further comprising: determining, by the computing device, an error occurred in the playback of the test audio data in response to determining that the audio data detected by the audio input device did not include the test audio data; responsive to determining that the error occurred, determining, by the computing device, a cause of the error; and outputting, by the computing device, an indication of the cause of the error.

Example 7. The method of example 1, wherein a frequency of an audio signal that encodes the test audio data is an ultrasonic frequency.

Example 8. The method of example 1, further comprising: responsive to determining that the audio data detected by the audio input device includes the test audio data: outputting, by the computing device and to the remote computing device, advisory audio data indicating the audio input device is ready to receive a spoken audio command; executing, based on the spoken audio command, an action.

Example 9. The method of example 8, wherein outputting the advisory audio data includes outputting the advisory audio data in response to receiving spoken audio input that includes a hotword indicating a request to process the spoken audio command.

Example 10. The method of example 1, further comprising: prior to outputting the test audio data, determining, by the computing device, characteristics of ambient audio within an environment that includes the computing device; and determining, by the computing device, characteristics of an audio signal that encodes the test audio data based at least in part on the characteristics of the ambient audio.

Example 11. The method of example 10, wherein determining the characteristics of the audio signal that encodes the test audio data includes determining a frequency of the signal that is not a harmonic of a frequency of the ambient audio.

Example 12. The method of example 1, wherein outputting the test audio data includes outputting a first portion of the test audio data, the method further comprising: prior to outputting the first portion of the test audio data, outputting, by the computing device, a second portion of the test audio data, the second portion of the test audio data including a first message and a second message, wherein a frequency of an audio signal that encodes the first portion of the test audio data is a first frequency associated with the first message, and wherein a frequency of an audio signal that encodes the second portion of the test audio data is a second frequency associated with the second message, the second frequency different than the first frequency.

Example 13. A computing device comprising at least one processor; and memory comprising instructions that, when executed by the at least one processor, cause the at least one processor to: output test audio data; determine whether audio data detected by an audio input device includes the test audio data; and responsive to determining that the test audio data was not detected by the audio input device, temporarily refrain from outputting advisory audio data indicating the audio input device is ready to receive a spoken audio command.

Example 14. The computing device of example 13, wherein execution of the instructions causes the at least one processor to output the test audio data to a vehicle computing device for output via a vehicle speaker, and receive the audio data from a first audio input device included in the computing device or from a second audio input device included in the vehicle.

Example 15. The computing device of example 13, wherein execution of the instructions causes the at least one processor to output, for display by a display device, a notification indicating that the test audio data was not detected in response to determining that the audio detected by the audio input device did not include the test audio data

Example 16. The computing device of example 13, wherein execution of the instructions causes the at least one processor to: determine an error occurred in the playback of the test audio data in response to determining that the audio data detected by the audio input device did not include the test audio data; responsive to determining that the error occurred, determine a cause of the error; and output an indication of the cause of the error

Example 17. The computing device of example 13, wherein execution of the instructions causes the at least one processor to: responsive to determining that the audio data detected by the audio input device includes the test audio data: output, to the remote computing device, advisory audio data indicating the audio input device is ready to receive a spoken audio command; and execute, based on the spoken audio command, an action.

Example 18. The computing device of example 13, wherein execution of the instructions causes the at least one processor to: prior to outputting the test audio data, determine characteristics of ambient audio with an environment that includes the computing device; and determine characteristics of an audio signal that encodes the test audio data based at least in part on the characteristics of the ambient audio.

Example 19. The computing device of example 13, wherein outputting the test audio data includes outputting a first portion of the test audio data, and wherein execution of the instructions causes the at least one processor to: prior to outputting the first portion of the test audio data, outputting, by the computing device, a second portion of the test audio data, the second portion of the test audio data including a first message and a second message, wherein a frequency of an audio signal that encodes the first portion of the test audio data is a first frequency associated with the first message, and wherein a frequency of an audio signal that encodes the second portion of the test audio data is a second frequency associated with the second message, the second frequency different than the first frequency.

Example 20. A computer-readable storage medium comprising instructions that, when executed by at least one processor of a computing device, cause the at least one processor: output, to a remote computing device, test audio data; determine whether audio data detected by an audio input device includes the test audio data; and responsive to determining that the test audio data was not detected by the audio input device, temporarily refrain from outputting advisory audio data indicating the audio input device is ready to receive a spoken audio command.

In one or more examples, the functions described may be implemented in hardware, software, firmware, or any combination thereof If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
outputting, by a computing device, test audio data;
determining, by the computing device, whether audio data detected by an audio input device includes the test audio data; and
responsive to determining that the test audio data was not detected by the audio input device, temporarily refraining, by the computing device, from outputting advisory audio data indicating the audio input device is ready to receive a spoken audio command.

2. The method of claim 1, wherein outputting the test audio data includes outputting the test audio data via one or more speakers of the computing device.

3. The method of claim 1, wherein outputting the test audio data comprises:
outputting, by the computing device, to a different computing device for output via one or more speakers of the different computing device, the test audio data.

4. The method of claim 3, further comprising:
receiving the audio data from a first audio input device included in the computing device or from a second audio input device of the different computing device.

5. The method of claim 1, further comprising:
outputting, by the computing device, for display by a display device, a notification indicating that the test audio data was not detected in response to determining that the audio detected by the audio input device did not include the test audio data.

6. The method of claim 1, further comprising:
determining, by the computing device, an error occurred in the playback of the test audio data in response to determining that the audio data detected by the audio input device did not include the test audio data;
responsive to determining that the error occurred, determining, by the computing device, a cause of the error; and
outputting, by the computing device, an indication of the cause of the error.

7. The method of claim 1, wherein a frequency of an audio signal that encodes the test audio data is an ultrasonic frequency.

8. The method of claim 1, further comprising:
responsive to determining that the audio data detected by the audio input device includes the test audio data:
outputting, by the computing device, advisory audio data indicating the audio input device is ready to receive a spoken audio command; and
executing, based on the spoken audio command, an action.

9. The method of claim 8, wherein outputting the advisory audio data includes outputting the advisory audio data in response to receiving spoken audio input that includes a hotword indicating a request to process the spoken audio command.

10. The method of claim 1, further comprising:
prior to outputting the test audio data, determining, by the computing device, characteristics of ambient audio within an environment that includes the computing device; and
determining, by the computing device, characteristics of an audio signal that encodes the test audio data based at least in part on the characteristics of the ambient audio.

11. The method of claim 10, wherein determining the characteristics of the audio signal that encodes the test audio data includes determining a frequency of the signal that is not a harmonic of a frequency of the ambient audio.

12. The method of claim 1, wherein outputting the test audio data includes outputting a first portion of the test audio data, the method further comprising:
prior to outputting the first portion of the test audio data, outputting, by the computing device, a second portion of the test audio data, the second portion of the test audio data including a first message and a second message,
wherein a frequency of an audio signal that encodes the first portion of the test audio data is a first frequency associated with the first message, and
wherein a frequency of an audio signal that encodes the second portion of the test audio data is a second frequency associated with the second message, the second frequency different than the first frequency.

13. A computing device comprising:
at least one processor; and
memory comprising instructions that, when executed by the at least one processor, cause the at least one processor to:
output test audio data;
determine whether audio data detected by an audio input device includes the test audio data; and
responsive to determining that the test audio data was not detected by the audio input device, temporarily refrain from outputting advisory audio data indicating the audio input device is ready to receive a spoken audio command.

14-15. (canceled)

16. The computing device of claim 13, wherein the instructions that cause the at least one processor to output the test audio data comprise instructions that cause the at least one processor to:
output the test audio data via one or more speakers of the computing device; or
output, to a different computing device for output via one or more speakers of the different computing device, the test audio data.

17. The computing device of claim 13, wherein the instructions further cause the at least one processor to:
determine an error occurred in the playback of the test audio data in response to determining that the audio data detected by the audio input device did not include the test audio data;
responsive to determining that the error occurred, determine a cause of the error; and
output an indication of the cause of the error.

18. The computing device of claim 13, wherein the instructions further cause the at least one processor to:
responsive to determining that the audio data detected by the audio input device includes the test audio data:
output advisory audio data indicating the audio input device is ready to receive a spoken audio command; and
execute, based on the spoken audio command, an action.

19. A computer-readable storage medium comprising instructions that, when executed by at least one processor of a computing device, cause the at least one processor to:
output test audio data;
determine whether audio data detected by an audio input device includes the test audio data; and
responsive to determining that the test audio data was not detected by the audio input device, temporarily refrain from outputting advisory audio data indicating the audio input device is ready to receive a spoken audio command.

20. The computer-readable storage medium of claim 19, wherein the instructions that cause the at least one processor to output the test audio data comprise instructions that cause the at least one processor to:
output the test audio data via one or more speakers of the computing device; or output, to a different computing device for output via one or more speakers of the different computing device, the test audio data.

21. The computer-readable storage medium of claim 19, wherein the instructions further cause the at least one processor to:
determine an error occurred in the playback of the test audio data in response to determining that the audio data detected by the audio input device did not include the test audio data;
responsive to determining that the error occurred, determine a cause of the error; and
output an indication of the cause of the error.

22. The computer-readable storage medium of claim 19, wherein the instructions further cause the at least one processor to:
responsive to determining that the audio data detected by the audio input device includes the test audio data:
output advisory audio data indicating the audio input device is ready to receive a spoken audio command; and
execute, based on the spoken audio command, an action.
